(19) United States
(12) Patent Application Publication
(10) Pub. No.: US 2025/0376362 A1
(43) Pub. Date: Dec. 11, 2025

(54) Device, Method and System for the Operation of an Industrial Truck in a Warehouse

(71) Applicant: STILL GmbH, Hamburg (DE)

(72) Inventors: Ralf Koenig, Adendorf (DE); Sven Dierfeld, Hamburg (DE); Johannes Hinckeldeyn, Hamburg (DE); Dennis Schüthe, Buchholz (DE); Lukas Hindemith, Buchholz (DE); Ansgar Bergmann, Bargteheide (DE); Ansgar Howey, Ahrensburg (DE)

(21) Appl. No.: 19/233,500

(22) Filed: Jun. 10, 2025

(30) Foreign Application Priority Data
Jun. 11, 2024 (DE) 10 2024 116 308.9

(51) Int. Cl. B66F 9/075; G01K 1/02

(52) U.S. Cl. CPC B66F 9/0755; G01K 1/026; G01K 2213/00

(57) ABSTRACT

A data processing device or control unit is used for the operation of an industrial truck for the transport of a plurality of objects in a warehouse. The data processing device includes an interface which is configured for the reception of a plurality of sensor data from the industrial truck during the movement of the industrial truck in the warehouse. The plurality of sensor data includes a plurality of thermal imaging data of the environment of the industrial truck. The data processing device further includes a processor device which is configured to create and/or to update a temperature map of the warehouse on the basis of the plurality of thermal imaging data. The temperature map indicates respective temperature values for a plurality of points of the warehouse. The data processing device or control unit can be part of the industrial truck or a free-standing server.

### CROSS-REFERENCE TO RELATED APPLICATION

This application claims priority to German Patent Application No. 10 2024 116 308.9 filed Jun. 11, 2024, the disclosure of which is hereby incorporated by reference in its entirety.

### BACKGROUND OF THE INVENTION

### Field of the Invention

The invention relates to a device, a method and a system for the operation of an industrial truck, in particular a fork lift truck, in a warehouse.

### Description of Related Art

Load carriers such as wire mesh boxes or pallets, in particular Euro-pallets, are frequently used for the transport and storage of products, goods and materials. Industrial trucks such as fork lift trucks and similar vehicles, for example, are used for the handling of such load carriers, e.g. in intralogistics, i.e. the internal flow of materials, e.g. in a warehouse. A warehouse is generally a very dynamic environment in which mobile industrial trucks are conventionally controlled either manually or in partly or fully automated operation.

Modern industrial trucks are frequently equipped with sensor units, for example video cameras, which are configured to sense the environment of the respective industrial truck so that information relating to the environment such as a warehouse, for example, can be acquired in particular to manage warehouses and to control the industrial truck on the basis of the sensor data acquired, in particular in partly or fully automated operation.

For some time, increasing importance has been paid to energy management as part of building management, including for warehouses. The objective of energy management is generally to minimize energy use, for example for heating or cooling, in a warehouse, as well as the related emissions and energy consumption.

### SUMMARY OF THE INVENTION

Against this background, the object of the invention is to make available an improved device as well as an improved method and system for the operation of an industrial truck in a warehouse.

According to a first aspect, this object is accomplished by a data processing device for the operation of an industrial truck in a warehouse, wherein the industrial truck is configured for the transport of a plurality of objects in the warehouse. The data processing device according to the first aspect comprises an interface which is configured to receive a plurality of sensor data from the industrial truck as the industrial truck moves in the warehouse, wherein the plurality of sensor data comprises a plurality of thermal imaging data of the environment of the industrial truck. The data processing device according to the first aspect further comprises a processor device which is configured to create and/or to update a temperature map of the warehouse on the basis of the plurality of thermal imaging data, wherein the temperature map indicates a respective temperature value for a plurality of points of the warehouse.

According to one embodiment, the plurality of sensor data of the industrial truck also comprises a plurality of position data of the industrial truck, wherein the processor device is configured to create or to update the temperature map of the warehouse on the basis of the plurality of thermal imaging data and the plurality of position data.

In one embodiment, the processor device is further configured, on the basis of the plurality of position data of the industrial truck, to generate control signals for the industrial truck, wherein the control signals are configured to move, i.e. to control, the industrial truck in the warehouse, for example to execute a transport order.

According to one embodiment, the processor device is further configured to recognize the objects of the plurality of objects on the basis of the sensor data by use of an object recognition mechanism and to determine a temperature for each recognized object on the basis of the temperature map.

In one embodiment, the object recognition mechanism is an artificial neural network which is configured to recognize the objects of the plurality of objects and to determine a temperature for each recognized object on the basis of the temperature map.

According to one embodiment, the processor device is further configured to monitor, on the basis of the temperature map by use of a monitoring mechanism, whether the temperature at one or more of the plurality of points in the warehouse is within a respective predefined temperature range, e.g. below a maximum temperature threshold.

In one embodiment, the monitoring mechanism comprises an artificial neural network which is configured to monitor whether the temperature at one or more of the plurality of points in the warehouse is within a respective predefined temperature range.

According to a second aspect, the object stated above is accomplished by an industrial truck, in particular a fork lift truck, for the transport of a plurality of objects in a warehouse. The industrial truck thereby comprises a data processing device according to the first aspect and a thermal image acquisition device, in particular a thermal imaging camera, wherein the thermal image acquisition device is configured to acquire the plurality of sensor data with the plurality of thermal imaging data of the environment of the industrial truck.

In one embodiment, the industrial truck according to the second aspect can further comprise drive means that are configured to move the industrial truck in the warehouse on the basis of control signals.

According to one embodiment, the industrial truck can further comprise load handling means, in particular forks, wherein the load handling means, in particular load forks, are configured to be moved on the basis of control signals relative to an object, for example a load carrier, to pick up the object.

According to a third aspect, the object stated above is accomplished by a system for the operation of a plurality of industrial trucks in a warehouse. The system according to the third aspect comprises a plurality of industrial trucks according to the second aspect and a data processing device according to the first aspect for the operation of the plurality of industrial trucks in the warehouse.

According to a fourth aspect, the object stated above is accomplished by a method for the operation of an industrial truck for the transport of a plurality of objects in a warehouse. The method according to the fourth aspect comprises the following steps:
reception of a plurality of sensor data from the industrial truck during the movement of the industrial truck in the warehouse, wherein the plurality of sensor data comprises a plurality of thermal imaging data of the environment of the industrial truck; and
creating and/or updating of a temperature map of the warehouse on the basis of the plurality of thermal imaging data, wherein the temperature map indicates an individual temperature value for a plurality of points of the warehouse.

The method according to the fourth aspect can be carried out by use of the data processing device according to the first aspect. Therefore, additional embodiments of the method according to the fourth aspect result from the embodiments described above and below of the data processing device according to the first aspect.

Additional advantages and details of the invention are described in greater detail below with reference to the exemplary embodiments illustrated in the accompanying schematic figures.

### BRIEF DESCRIPTION OF THE DRAWINGS

The terms Fig., Figs., Figure, and Figures are used interchangeably in the specification to refer to the corresponding figures in the drawings.

FIG. 1 is a schematic illustration of an industrial truck for the transport of objects in a warehouse according to one embodiment;

FIG. 2 is a schematic illustration of a system according to the invention with a plurality of industrial trucks and a central data processing device according to one embodiment; and

FIG. 3 is a flow diagram with steps of a method for the operation of an industrial truck for transporting objects in a warehouse according to one embodiment.

### DESCRIPTION OF THE INVENTION

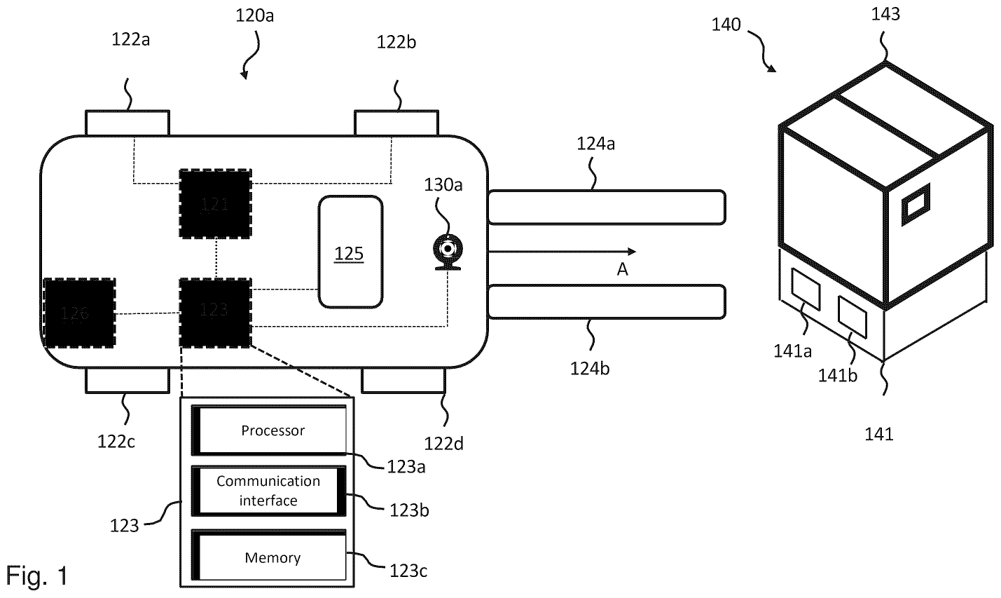

FIG. 1 is a schematic illustration of an industrial truck 120a according to one embodiment for transporting objects 140 in an industrial environment, in particular in a warehouse. The industrial truck 120 can in particular be a partly autonomous, semi-autonomous and/or manually operated fork lift truck 120a, i.e. in manual operation operated manually by an operator. The objects 140 can be, for example, objects 143 such as packing boxes 143 that are located on a respective load carrier 141. The load carrier 141 can be, for example, a pallet 141, in particular a Euro-pallet 141 or a wire mesh box 141.

As illustrated in FIG. 1, the industrial truck 120a can comprise load handling means in the form of a pair of load forks 124a,b, which are configured to be introduced into respective recesses, in particular pockets 141a,b, on one end side of a load carrier 141, to pick up the cargo carrier 141 and the objects 143 located on it. According to additional embodiments, the load handling means can also be configured as a pin, for example to pick up rolls of film or wire coils, as handling means that engage the load from below (e.g. comparable to the load handling means on waste trucks to pick up waste bins), or as bale and roll clamps, for example, to pick up rolls of paper.

The industrial truck 120a illustrated in FIG. 1 further comprises a drive unit 121, for example at least one motor 121, in particular a battery-powered electric motor 121, wherein the drive unit 121 is configured to move the industrial truck 120a and the pair of load forks 124a,b relative to the object 140, for example to change the orientation and/or the distance between the industrial truck 120a and the object 140, in particular to change the load carrier 141 and/or to raise or lower the pair of load forks 124a,b. For this purpose, as illustrated in FIG. 1, the drive unit 121 can be appropriately connected with wheels 122a-d and/or the pair of load forks 124a,b of the industrial truck 120a. The industrial truck 120a can further comprise a display and/or control panel 125 for the display of information and/or the operation of the industrial truck 120a.

According to the invention, the industrial truck 120a comprises a sensor unit 130a which comprises a thermal image acquisition unit 130a, which is configured, during the movement of the industrial truck 120a, to acquire a plurality of thermal images of the environment of the industrial truck 120a in the warehouse. The thermal image acquisition unit 130a preferably comprises an infrared camera 130a. In addition to a thermal image acquisition unit, the sensor unit 130a can comprise additional sensors, in particular a LIDAR sensor 130a and/or a radar sensor 130a for the acquisition of the environment of the industrial truck 120a, for example for the acquisition of position data of the industrial truck 120a, i.e. of data that make possible a relative and/or absolute determination of the position of the industrial truck 120a in the warehouse.

As indicated in FIG. 1, the sensor unit 130a in the form of the thermal image acquisition unit 130a can preferably be mounted on the industrial truck 120a so that a field of view 131a of the thermal image acquisition unit 130a lies essentially along a direction A of forward motion of the industrial truck 120a. The thermal image acquisition unit 130a can preferably be mounted in the plane of symmetry between the two load forks 124a,b. In addition to the thermal image acquisition unit 130a with the field of view along the direction A of forward movement of the industrial truck 120a, the industrial truck 120a can further comprise additional sensor units, for example a sensor unit with a field of view along a direction of reverse movement of the industrial truck 120a and/or a sensor unit with a field of view at a right angle to the direction A of forward movement of the industrial truck 120a.

According to the invention, the industrial truck 120a further comprises a data processing device 123 (also called a control unit 123) which, for example, can comprise one or more processors or micro-controllers 123a with appropriate software and is configured for the at least partly automated control of the industrial truck 120a. As illustrated in FIG. 1, the data processing device or control unit 123 further comprises a communication interface 123b, in particular to receive thermal imaging data from the thermal image acquisition unit 130a, as well as a data storage device 123c, in particular a non-volatile memory 123c. The data storage device 123c can be configured to store data and executable program code which, when executed by the processor 123a of the data processing device or control unit 123, causes the processor 123a to perform the functions, operations and processes described below.

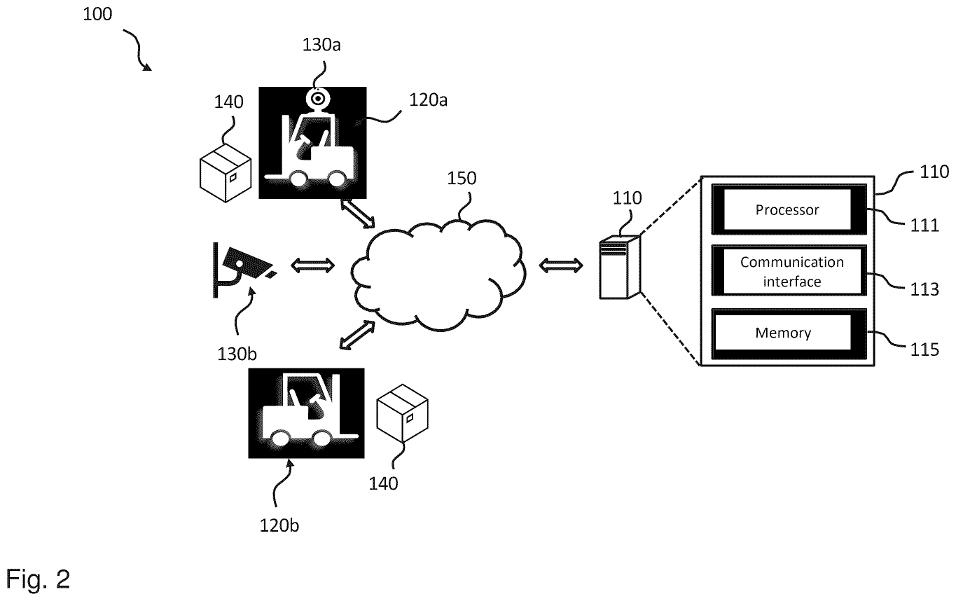

FIG. 2 is a schematic illustration of a system 100 according to the invention for the operation of the industrial truck 120a and one or more additional industrial trucks 120b, each of which can be operated fully automatically, semi-automatically and/or manually, to carry out transport orders for the transport of objects 140 in the warehouse.

The system 100 comprises, in addition to the plurality of industrial trucks 120a,b, a central data processing device 110, for example a server 110, which is configured to communicate with each industrial truck 120a,b of the plurality of industrial trucks 120a,b, for example to transmit transport orders to each of the plurality of industrial trucks 120a,b for the transport of objects 140 in the warehouse. For this purpose, for example, the industrial truck 120a comprises a communication interface 126 which is configured to communicate with a corresponding communication interface 113 of the central data processing device 120, for example via a wireless communication network 150, e.g. a WLAN network or a cellular network. By use of a wireless communication network 150 of this type, the industrial truck 120a and/or the central data processing device 110 can further communicate with an additional external sensor unit 130b, such as, for example, an additional thermal imaging camera 130b installed in an aisle of the warehouse. The central data processing device 110 illustrated in FIG. 2, can be, for example, an industrial PC 110 or a cloud server, in particular an edge cloud server 110.

As illustrated in FIG. 2, the central data processing device 110 comprises a communication interface 113, one or more processors 111 and a data storage device 115, in particular a non-volatile memory 115. The data storage device 115 can be configured to store data and executable program code which, when executed by the processor 111 of the central data processing device 110, causes the processor 111 to perform the functions, operations and processes described below.

According to the invention, the data processing device in the form of the control unit 123 of the industrial truck 120a in FIG. 1 or in the form of the central data processing device 110 in FIG. 2 is configured to receive via the respective interface 123b or 113 a plurality of sensor data from the industrial truck 120 as the industrial truck 120a moves in the warehouse, wherein the plurality of sensor data comprises a plurality of thermal imaging data of the environment of the industrial truck 120a. Additionally, the respective processor device, i.e. the control device 123a of the industrial truck 120 in FIG. 1 or the processor 111 of the central data processing device 110 in FIG. 2, is configured, on the basis of the plurality of thermal imaging data, to create and/or to update a temperature map of the warehouse, wherein the temperature map indicates an individual temperature value, i.e. a temperature, for each of a plurality of points in the warehouse. In one embodiment, the temperature map is a three-dimensional temperature map which indicates a respective temperature value for each of a plurality of points in the three-dimensional space of the warehouse.

As described above, the plurality of sensor data from the industrial truck 120 can comprise, in addition to the thermal imaging data, a plurality of position data of the industrial truck 120a. In that case, the processor device, i.e. the control device 123a of the industrial truck 120a in FIG. 1 or the processor 111 of the central data processing device 110 in FIG. 2, can be configured to create and/or update the temperature map of the warehouse on the basis of the plurality of thermal imaging data and the plurality of position data of the industrial truck 120a. In one embodiment, the processor device, i.e. the control device 123a of the industrial truck 120a in FIG. 1 or the processor 111 of the central data processing device 110 in FIG. 1 can further be configured to generate control signals for the industrial truck 120a on the basis of the plurality of position data of the industrial truck 120a, wherein the control signals are configured to move the industrial truck 120a in the warehouse.

As described above, for the acquisition of the position data, the sensor unit 130a of the industrial truck 120a can comprise, in addition to the thermal imaging camera 130a for example, a LIDAR sensor, in particular a 3D LiDAR sensor. By use of a suitable calibration of the thermal imaging camera and of the LiDAR sensor and a merging of the thermal imaging data and the position data, the temperature map can be created in the form of a 3D point cloud with temperature values by the processor device, i.e. the control device 123a of the industrial truck 120a in FIG. 1 or the processor 111 of the central data processing device 110 in FIG. 2.

In other words, the temperature values acquired by use of the thermal imaging camera are therefore associated with a point in the three-dimension space, the result of which is a highly precise three-dimensional temperature map. The advantage of the movement of the industrial truck 120a and therefore of the sensor device 130a is that the position data, i.e. points of the LIDAR sensor, can be supplemented in a high-resolution temperature map. According to one embodiment, the temperature map is thereby not created only once, but is continuously updated on the basis of new data. For that purpose, a current temperature value can be algorithmically associated with a geometric point in the temperature map in the form of a point cloud and therefore updated. The result is a dynamic 3D temperature map which is capable of portraying the curve of the temperature over time at any desired locations in a warehouse.

As the person having average skill in the art will be aware, the temperature map prepared on the basis of thermal imaging data and position data represents a type of “digital twin” of the warehouse. The creation of a digital twin of this type in the form of a map on the basis of position data is known from DE 10 2022 105 079 and DE 10 2021 133 614, for example, which are hereby incorporated by reference in their entirety and to which reference is made for further details.

According to one embodiment, in addition to the thermal imaging data and the position data, additional data acquired by the sensor device 130a can be included in the generation of the digital twin, for example the relative humidity, carbon dioxide concentration, noise level etc. For example, the sensor device 130a can further comprise one or more microphones (in particular a microphone array) in which the direction from which an acoustic signal is received can also be determined and, according to the location and arrangement of the microphones, the distance from the source. The sensor device 130a can further be configured to measure the strength of cellular signals in the warehouse, to determine what networks are present in the warehouse, at what signal level and in what frequency band (to identify sources of interference or to switch to another frequency band or modulation signal).

According to one embodiment, the processor device, i.e. the control device 123a of the industrial truck 120a in FIG. 1 or the processor 111 of the central data processing device 110 in FIG. 2, can be configured to recognize the plurality of objects 140 on the basis of the sensor data by use of an object recognition mechanism and to determine a temperature for each object 140 recognized on the basis of the temperature map. In an embodiment of this type, the sensor data can comprise in particular image data of the objects 140 that are acquired with an optical camera of the sensor unit 130a. In one embodiment, the object recognition mechanism can comprise an artificial neural network or be implemented by use of an artificial neural network which is configured to recognize the object of the plurality of objects 140 in the image data (for example, to determine one type of an individual object 140) and, on the basis of the temperature map, to determine a temperature for each object 140 recognized.

According to one embodiment, the processor device, i.e. the control device 123a of the industrial truck 120a in FIG. 1 or the processor 111 of the central data processing device 110 in FIG. 2, can further be configured, on the basis of the temperature map, to monitor by use of a monitoring mechanism whether the temperature at one or more of the plurality of points in the warehouse is within a respective predefined temperature range, for example that it does not exceed a maximum temperature threshold. In one embodiment, the monitoring mechanism can comprise an artificial neural network or be implemented by use of an artificial neural network which is configured to monitor whether the temperature at one or more of the plurality of points in the warehouse is within a respective predefined temperature range.

For example, a Machine Learning Model (ML model), in particular an artificial neural network, can be generated by use of training data, which is thereby configured to detect inadmissible conditions, e.g. that certain points on an exterior wall of the warehouse are too cool, or that the temperature at certain points in a refrigerated storage area of the warehouse is too high. These configurations can differ, depending on the location in which they are used. In other words, according to one embodiment a fully-trained ML model, in particular an artificial neural network, can be used as interference to give alarm notifications to a user.

In an additional embodiment, the temperature of the objects 140 in a warehouse can be determined by use of the thermal imaging camera of the sensor device 130a, for example, during the transport of an object 140 with the industrial truck 120a. The temperature of the object 140 can therefore be monitored over extended periods of time in storage. The monitoring can be performed, for example, by an operator by use of a flag setting or definition of a threshold via a mobile application on a tablet/smartphone or via an AR/VR device. The object can then be tracked throughout its time in storage, and an alarm can be sent if a threshold is exceeded. The alarm can be silenced manually or automatically by coupling to a building management system (reduction of the temperature in the warehouse).

As described above, the processor device, i.e. the control device 123a of the industrial truck 120a in FIG. 1 or the processor 111 of the central data processing device 110 in FIG. 2 can implement an artificial neural network which is configured to recognize and/or classify the objects (e.g. in categories such as meat, seafood, fruits etc.) and is trained on which temperature value may not be exceeded for each category of object. In an additional embodiment, energy prices can also be monitored to cool the warehouse when electricity costs are low. Positions in the warehouse that remain cold for long periods can be used for the storage of temperature-sensitive objects, e.g. so that the object can be relocated when electricity is more expensive and there are additional sufficiently cold areas in the warehouse.

As the person with average skill in the art is aware, a plurality of processes in a warehouse such as, for example, the placement of objects or the control of HVAC systems, can be made more efficient by use of the temperature map created by the processor device, i.e. the control device 123a of the industrial truck 120a in FIG. 1 or the processor 111 of the central data processing device 110 in FIG. 2. In the pharmaceutical industry, for example, certain medications and active substances must be produced and stored under controlled conditions to guarantee their effectiveness and safety. In the food industry, certain products must be manufactured and stored under controlled conditions to ensure their quality and shelf life. In the electronics industry, certain products must be manufactured and stored under controlled conditions to ensure their performance and reliability. In the automobile industry, certain components must be manufactured and stored under controlled conditions to ensure their performance and safety.

By use of the embodiments described herein, the temperature (and optionally additional physical variables) at different points in a warehouse can be monitored and analyzed in real time. As described above, the results of the monitoring in the form of the temperature map can be integrated into an artificial neural network to make possible a more accurate prediction of the environment in the warehouse and to optimize the processes in the warehouse. For example, to prevent thermal bridges in a warehouse, the artificial neural network can be trained and configured to reduce heat sources in a warehouse. This can be accomplished, for example, in the form of changes in the storage of the objects, e.g. to place materials that provide effective thermal insulation on the outsides of the warehouse building and to store other objects that must be kept cooler in the middle of the warehouse. The change in temperature over time on surfaces in the warehouse can also be determined, e.g. the temperature changes on surfaces of building parts, objects or machinery in the warehouse can be detected. It thereby becomes possible to reach conclusions regarding defects, malfunctions or anomalies, e.g. overheating of machinery, damage to the building or to packaging materials in the warehouse.

The thermal insulation of a warehouse and the orientation of the HVAC units (i.e. heating and cooling equipment) can also be optimized by use of the temperature map created by use of the processor device, i.e. of the control device 123a of the industrial truck 120a in FIG. 1 or the processor 11 of the central data processing device 110 in FIG. 1. The efficiency of energy management in a warehouse can be tracked very accurately and over time. Thermal leaks that result in condensate or the formation of ice can also be more easily detected. Improved control of the cold chain of the products in the warehouse also becomes possible. It thereby becomes possible to reach conclusions concerning Quality Assurance by keeping track of the cold chain. It also becomes easier to identify damage to production equipment. Variances and deformations in the products produced can also be prevented. The 3D temperature map can be integrated into the BIM model of the warehouse.

According to an additional embodiment, the temperature map created by the processor device, i.e. the control device 123a of the industrial truck 120a in FIG. 1 or the processor 111 of the central data processing device 110 in FIG. 2, can also be used by a warehouse building management system, which can also be implemented in the central data processing device 110. The building management system of a warehouse can operate as follows, for example, on the basis of the temperature map. The temperature in the warehouse building must be kept as constant as possible. If the temperature in the building increases, an overhead door of the building can be opened so that the air conditioning system does not have to run. The overhead door can be closed automatically if the logic circuits detect an increase greater than a maximum in the area. It thereby becomes possible to conserve energy resources.

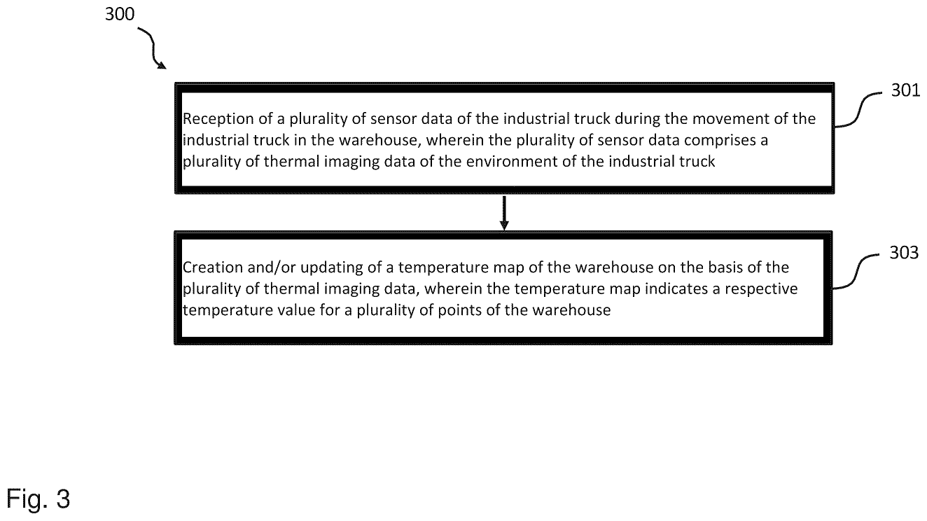

FIG. 3 is a flow diagram with steps of a method 300 for the operation of an industrial truck 120a for transporting objects 140 in a warehouse. The method comprises a step 301 of the reception of a plurality of sensor data from the industrial truck 120a during the movement of the industrial truck 120a in the warehouse, wherein the plurality of sensor data comprises a plurality of thermal imaging data of the environment of the industrial truck 120a. The method 300 further comprises a step 303 of the creation and/or updating of a temperature map of the warehouse on the basis of the plurality of thermal image data, wherein the temperature map indicates respective temperature values for a plurality of points of the warehouse.

The method 300 according to the invention can be carried out by uses of the data processing device 123, 110 according to the invention. Additional embodiments of the method 300 according to the invention result from the embodiments of the data processing device 123, 110 described above and below.

1. A data processing device for operation of an industrial truck for transport of a plurality of objects in a warehouse, wherein the data processing device comprises:
an interface which is configured for reception of a plurality of sensor data from the industrial truck during movement of the industrial truck in the warehouse, wherein the plurality of sensor data comprises a plurality of thermal imaging data of an environment of the industrial truck; and
a processor device which is configured to create and/or to update a temperature map of the warehouse on a basis of the plurality of thermal imaging data, wherein the temperature map indicates respective temperature values for a plurality of points of the warehouse.

2. The data processing device according to claim 1, wherein the plurality of sensor data of the industrial truck further comprises a plurality of position data of the industrial truck, and wherein the processor device is configured to create or to update the temperature map of the warehouse on the basis of the plurality of thermal image data and the plurality of position data.

3. The data processing device according to claim 2, wherein the processor device is further configured to generate control signals for the industrial truck on the basis of the plurality of position data of the industrial truck, wherein the control signals are configured to move the industrial truck in the warehouse.

4. The data processing device according to claim 1, wherein by use of an object recognition mechanism, the processor device is further configured to recognize objects of a plurality of objects on the basis of the sensor data and to determine a temperature for each object recognized on the basis of the temperature map.

5. The data processing device according to claim 4, wherein the object recognition mechanism is an artificial neural network which is configured to recognize the objects of the plurality of objects and to determine a temperature for each object recognized on the basis of the temperature map.

6. The data processing device according to claim 1, wherein the processor device is further configured to monitor, on the basis of the temperature map by use of a monitoring mechanism, whether the temperature at one or more of the plurality of points in the warehouse is within a respective predefined temperature range.

7. The data processing device according to claim 6, wherein the monitoring mechanism comprises an artificial neural network which is configured to monitor whether the temperature at one or more of the plurality of points in the warehouse is within a respective predefined temperature range.

8. An industrial truck for transport of a plurality of objects in a warehouse, wherein the industrial truck comprises a data processing device according to claim 1 and a thermal image acquisition device, wherein the thermal image acquisition device is configured to acquire the plurality of thermal imaging data of the environment of the industrial truck.

9. A system for operation of a plurality of industrial trucks in a warehouse, wherein the system comprises:
a plurality of industrial trucks according to claim 8; and
a data processing device according to claim 1 for the operation of the plurality of industrial trucks in the warehouse.

10. A method for operation of an industrial truck for transport of a plurality of objects in a warehouse, wherein the method comprises:
receiving a plurality of sensor data from the industrial truck during movement of the industrial truck in the warehouse, wherein the plurality of sensor data comprises a plurality of thermal imaging data of an environment of the industrial truck; and
creating and/or updating a temperature map of the warehouse on a basis of the plurality of thermal image data, wherein the temperature map indicates respective temperature values for a plurality of points of the warehouse.
